(19) United States
(12) Patent Application Publication
(10) Pub. No.: US 2003/0067623 A1
(43) Pub. Date: Apr. 10, 2003

(54) System for reading image information

(76) Inventor: Yuki Akiyama, Kawasaki-shi (JP)

Correspondence Address: REED SMITH HAZEL & THOMAS LLP, Suite 1400, 3110 Fairview Park Drive, Falls Church, VA, 22042, US

(21) Appl. No.: 09/970,892

(22) Filed: Oct. 5, 2001

(51) Int. Cl. G06F 15/00; G06F 13/00; H04B 1/38

(52) U.S. Cl. 358/1.15; 455/556

(57) ABSTRACT

An object of the present invention is to provide a system in which a user can read information of an image information display member such as a poster as digital image information such as JPEG by using image input means provided in a mobile communication system, and can record the information in recording means which is provided in the mobile communication system and which records a shot image.

The present invention comprises an image information display member such as a poster and a mobile communication system which reads an image information portion of the image information display member. The mobile communication system is provided with a photographing portion which shoots at least information of the image information portion, recording means for recording a shot image and a display portion for retrieving and displaying any of the recorded information.

### BACKGROUND OF THE INVENTION

1. Field of the Invention

The present invention relates to a mobile communication system for reading an image information display member such as a poster and an image information portion of the image information display member. In particular, the present invention relates to a system which is configured to transfer image information shot by photographing means such as a photographing portion provided at a main body of the mobile communication system, a digital camera, a scanner or the like to the mobile communication system that another person carries and/or to a system which has a function of a communication terminal.

2. Description of the Related Art

Image information which is shot by image input means such as a digital camera, a scanner or the like is generally recognized as the image information with a file format referred to as JPEG. JPEG is an efficient recording format and is used for nature such as photographs. In JPEG, while an image quality is maintained, the size of a file can be compressed and a transmission time on an internet can be reduced. JPEG is usually programmed and managed so as to provide files with arbitrary names or to attach names to the files automatically.

For example, a telephone number, a fax number, so-called domain information such as a URL on an internet or an e-mail address are written into an image information display member such as a poster which now can be seen anywhere in towns. Further, there has been provided the image information display member which is considered to be necessary in our life such as time tables in stations, statements of virtues in spas or the like.

In order to obtain such information, paper medium such as a memo pad and means to write with such as a ball-point pen are usually needed. Alternatively, there has been utilized a method in which the information is temporarily recorded as a voice in a voice storage medium such as a tape recorder and then used.

Further, in a case in which the information is provided with a map, a user has to write down roads and boundaries of buildings by the hand. Subsequently, when a map with the image information is to be made, the shot image information and geographic information such as latitude and longitude must be prepared separately. Then, the image information and the geographic information need to be combined and edited.

Such work is not limited to the case in which maps are provided. For example, when a database for commodity catalogs or a clinical chart system including image information is to be formed, images obtained by shooting commodities or patients' affected areas and codes form an aging the commodities or clinical chart data are formed separately. Then, the images and the codes or the data need to be combined and edited.

However, the information written on a memo pad is difficult to read because of mistakes at the time of copying or bad handwritings. Such method is neither accurate nor sufficient to collect correct and detail information.

Moreover, in a case of audio recording, the information must be read on the spot. When the information is read, the information may be misread or the information may not collected successfully because of noises. Thus, the audio recording is not sufficient to collect correct and detail information. Further, a user has to carry the voice storage medium, which suffers the user.

### SUMMARY OF THE INVENTION

In order to solve the above-described drawbacks, an object of the present invention is to provide a system in which a user reads information of an image information display member such as a poster as digital image information such as JPEG by using image input means provided in a mobile communication system, and with which system recording means which is provided in the mobile communication system and is used to record a shot image is provided.

In a preferred embodiment of the present invention to accomplish such object, another object of the present invention is to provide a system in which a recorded image is made into database arbitrarily and/or automatically within the mobile communication system, and any of the recorded information can be retrieved and displayed if necessary.

Still another object of the present invention is to provide a system for reading digital image information such as JPEG in which the digital image information such as JPEG stored in the recording means is structured so as to be connected to a net line from a local area network (LAN).

A further object of the present invention is to provide a system for reading digital image information such as JPEG in which the digital image information such as JPEG stored in the recording means can be recorded in a recording medium such as a server system.

A still further object of the present invention is to provide a system for reading digital image information such as JPEG in which the digital image information such as JPEG stored in the recording medium can be copied to a recording medium such as an FD, an MD or a DVD, as well as P.P.

A still further object of the present invention is to provide a system for reading digital image information such as JPEG in which there is provided means for displaying a desired portion of the digital image information such as JPEG stored in the recording means in an enlarged manner at a time of output thereof.

When an image is outputted, text information input means which is arbitrarily selected by a user in accordance with the user's demand, image input means connected to the text information input means, and means for combining and outputting specific digital image information such as JPEG inputted by the image input means and specific text information inputted by the text information input means may be provided. However, the system of the present invention can be carried out without the latter means.

An overall characteristic of image information reading relating to the present invention is that an image information display member such as a poster and the image information portion of the image information display member are read by a mobile communication system which comprises at least a photographing portion for shooting information of the image information portion, recording means for recording the shot image, and a display portion for retrieving and displaying any of the recorded information.

Another characteristic of the present invention is that the photographing portion for shooting the information of the image information portion is photographing means such as a digital camera, a scanner or the like.

Still another characteristic of the present invention is that the digital image information such as JPEG stored in the recording means is structured to be transferred to a mobile communication system that another person carries and/or to a system having a function of a communication terminal.

A further characteristic of the present invention is that the digital image information such as JPEG stored in the recording means is structured to be connected to a net line from a local area network (LAN).

A still further characteristic of the present invention is that the digital image information such as JPEG stored in the recording means can be recorded in a recording medium such as a server system or the like.

A still further characteristic of the present invention is that the digital image information such as JPEG stored in the e recording means can be copied to a recording medium such as an FD, an MD and a DVD, as well as a P.P.

An additional characteristic of the present invention is that there is provided means for displaying the digital image information such as JPEG stored in the recording means in an enlarged manner at a time of output thereof.

The system of the present invention may comprise means for extracting a portion of the text information inputted by the text information input means and forming image information with text information. However, the system of the present invention can be carried out without the means.

As the text information input means, an existing ten-key which is provided in advance may be used when the information is managed by using a mobile communication such as a mobile telephone. When a notebook computer or a desktop computer is used, an existing input keyboard may be used as the text information input means.

The present invention has other superior objects, characteristics, operations and effects which will be described in an embodiment hereinafter.

### BRIEF DESCRIPTION OF THE DRAWINGS

FIG. 1 is a schematic flow chart of a system for fetching an image information display member by a photographing portion provided at a mobile communication system;

FIG. 2 is a view of an example of the mobile communication system with which the photographing portion relating to the present invention is provided;

FIG. 3 is a schematic flow chart 1 showing an overall structure of the present invention;

FIG. 4 is a view of an example of a case in which an enlargement function is used in a display portion provided at the mobile communication system;

FIG. 5 is a schematic flow chart 2 showing an overall structure of the present invention;

FIG. 6 is an example 1 of a menu screen displayed on a PC;

FIG. 7 is an example 2 of a menu screen displayed on a PC;

FIG. 8 is an example 3 of a menu screen displayed on a PC;

FIG. 9 is an example 4 of a menu screen displayed on a PC; and

FIG. 10 is a schematic view of a structure of a digital camera as a photographing portion relating to the present invention.

### DESCRIPTION OF THE PREFERRED EMBODIMENTS

One embodiment of the present invention will be described with reference to the drawings hereinafter. This embodiment is formed by an image information display member such as a poster (A) such as a poster and a mobile communication system (B) which reads an image information portion of the image information display member (A). Digital image information such as JPEG is recorded and stored by a photographing portion (C) which is provided at a main body of the mobile communication system (B) and which shoots information of the image information portion and recording means (D) which records the shot image. If necessary, any of the recorded information is retrieved and outputted on a display portion (E) provided in the mobile communication system (B).

The image information display member (A) described herein does not require special processing. Any image information display member may be included as long as it can be referred to as the image information which can appeal to the user's eye. Examples of the image information display member include, in addition to ordinary posters at stations, roads, waiting rooms and lobbies, signboards provided on the rooftops or at walls of buildings, time tables at stations or bus stops, statements of virtues at spas, paper ads such as newspapers or magazines, advertisement panels which utilize electronic medium such as a liquid crystal panel, a dot display, a cathode ray tube display, a seven-segments display, and advertisements provided on an internet.

As the image information display member, three-dimensional advertisements such as so-called disposable signboards, dolls which look like various kinds of animals and disposed in front of drugstores, mascot dolls which look like founders of restaurants or the like and disposed in front of the restaurants may be included.

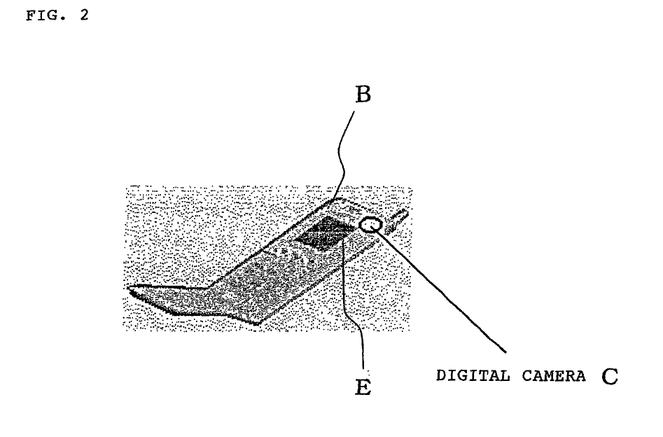

FIG. 2 shows a mobile communication system (B) which includes a photographing portion (C) for fetching the image. For example, specific names of types of the mobile communication system are, as existing products, J-D05 corresponding to J-PHONE which includes a mobile camera in which an artificial retina chip is built and 1 MB of mass memory and J-T06 corresponding to J-PHONE which includes a multi-functional mobile camera with a mobile flash. In this embodiment, the mobile communication system in which a digital camera is built as one example of the photographing portion is described. However, the mobile communication system is not limited to such system. Any mobile communication system can be used as long as it includes known photographing means, for example, a mobile communication system in which a scanner is built.

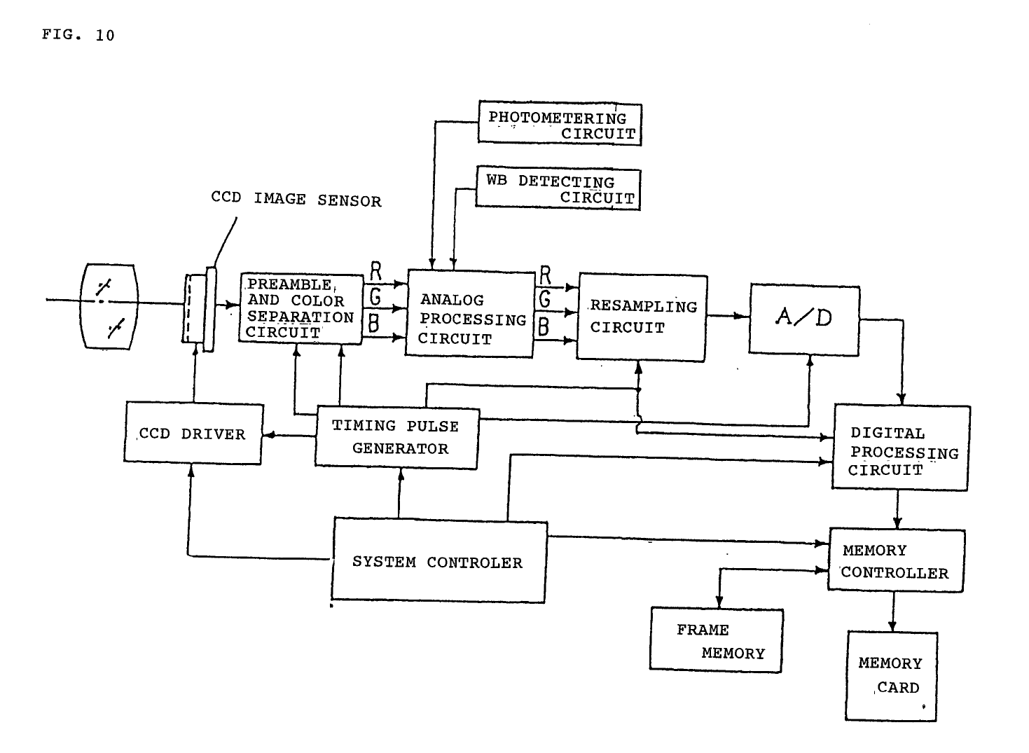

FIG. 10 shows a basic structure of a digital camera which is built in the mobile communication system (B). Any digital camera can be used as long as it includes at least a lens for fetching an image from outside, a CCD image sensor, a preamble and color separation circuit for converting the image into data, an analog processing circuit, a photometering circuit, a WB detecting circuit (a white balance detecting circuit) which photometering circuit and WB detecting circuit are necessary for the analog processing, a resampling circuit, an A/D, a digital processing circuit, a memory controller and a frame memory corresponding to the memory controller. Further, a system controller which serves as a central function for governing such components, a timing pulse generator, and a memory for storing the information should be provided in a driver.

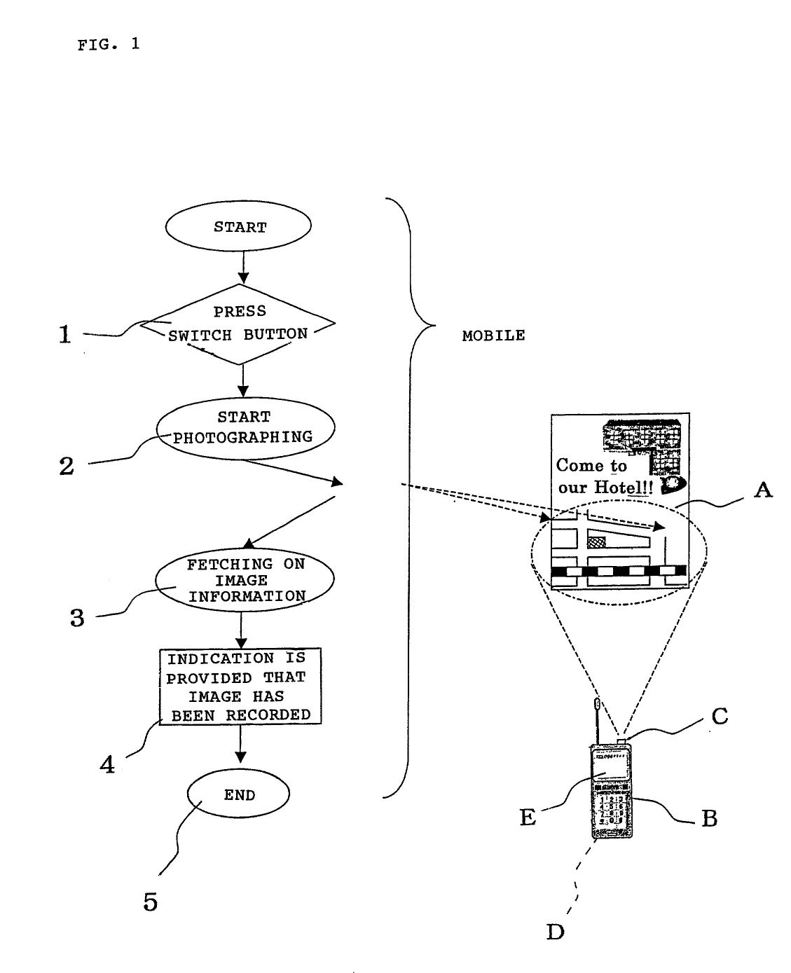

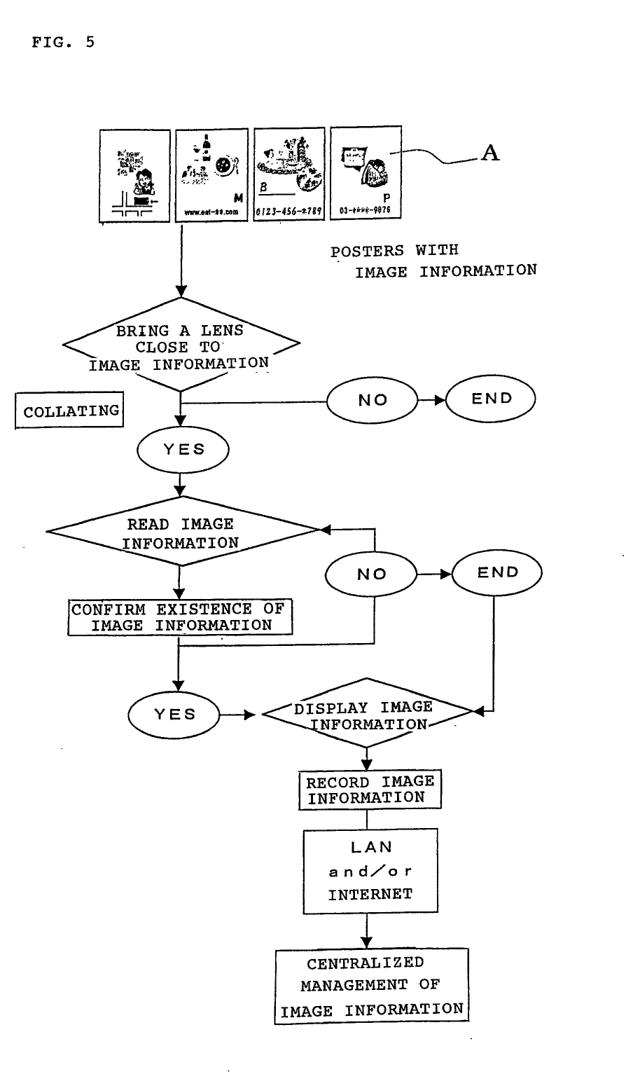

A series of processes for fetching an image as the image information will be described specifically. FIGS. 1 and 5 show an operation of photographing information by using a mobile such as the mobile communication system (B) in a time series from the top to the bottom of the charts.

In FIG. 1, assume that there is provided the image information display member (A) that a user wants to fetch. Firstly, a user directs the photographing portion (C) provided at the mobile communication system (B) to the image information display member (A), and focuses on it. Then, by pressing a predetermined switch button (1) provided at the mobile communication system (B), photographing starts (2). At this time, digital image information (G) is preferably fetched (3) while being outputted on a display portion (E) provided at the mobile communication system (B). If the shot image information (G) is tilted or if a tone of the shot image information is dark, so that a user does not like it, the start button (1) is pressed again and photographing is carried out again.

When an image that a user likes can be fetched, an indication is provided (4) on the display portion (E) provided at the mobile communication system (B) that the image has been recorded. Then, a user confirms that the image has been recorded in a memory provided in the mobile communication system (B). In this way, photographing ends (5).

If a plurality of image information display members (A) are to be photographed, the above-described operation is repeated for several times, and thus the operation is completed.

An image photographed by a digital camera is generally treated in a JPEG format. JPEG is an efficient recording format for nature such as photographs. In JPEG, the size of a file can be compressed or a transmission time on an internet can be reduced while an image quality is maintained. JPEG is usually programmed and managed so as to provide files with arbitrary names or to attach names to the files automatically. A management method of JPEG will be described later.

Further, the image is recognized temporarily as image information with JPEG file format. Then, if the image is an image into which predetermined text information, GIF, BMP or a thumbnail image information is added, by using any commercially available application software on an operating system Windows (Registered Trademark) supplied from Microsoft (Registered Trademark), the image can be restored in Exif format.

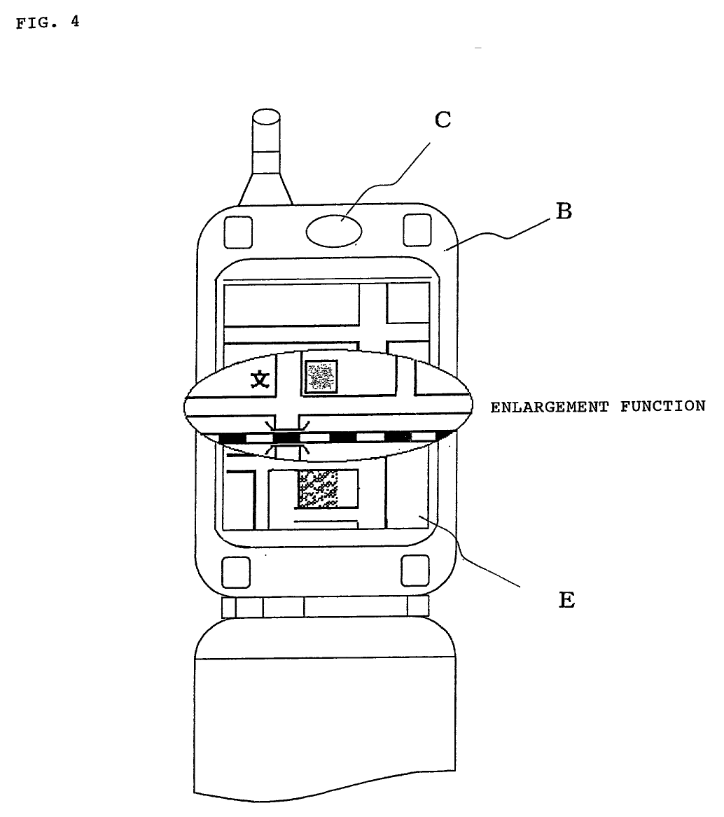

The fetched digital image information (G) is outputted on the display portion (E) which is provided at the mobile communication system (B) and then confirmed. As shown in FIG. 4, when a user outputs the digital image information, a desired portion thereof is preferably displayed in an enlarged manner.

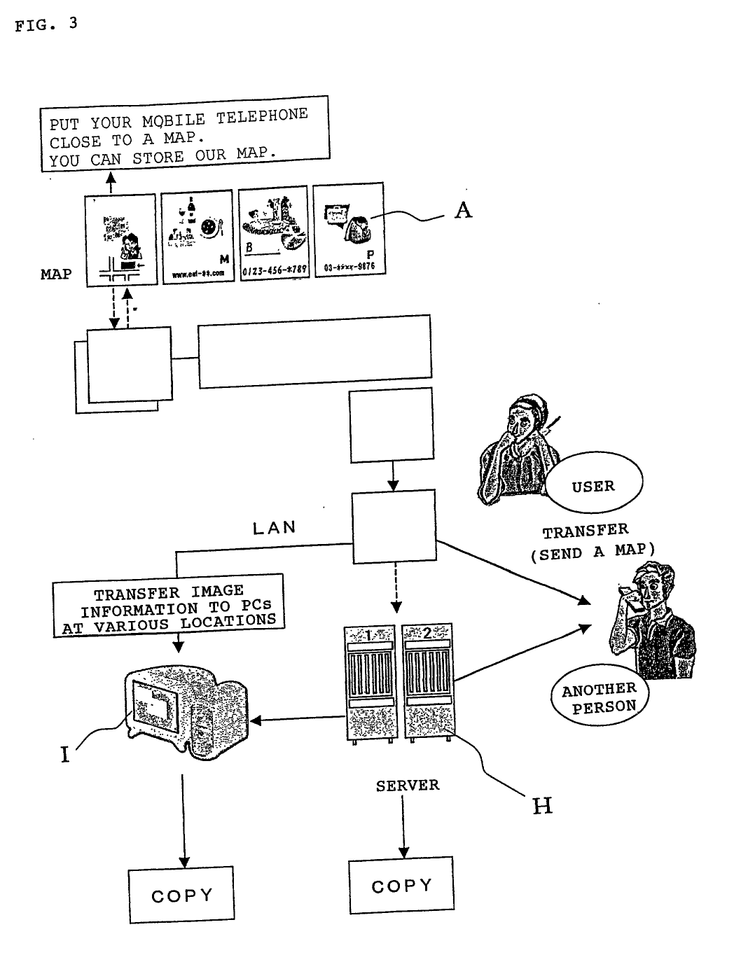

As shown in FIGS. 3 and 5, the fetched digital image information (G) is structured so as to be transferred to the mobile communication system (B) that another person carries and/or to a system which has a function of communication terminal (F).

Firstly, a description will be given of a method for transferring image information to the mobile communication system (B) that another person carries and/or to the system having a function of the communication terminal (F) by using the mobile communication system (B).

When the image information display member (A) is shot by using the mobile communication system (B) having the photographing portion (C), the digital image information (G) is temporarily and/or permanently stored in recording means (D) of the mobile communication system (B) which is usually referred to as a memory. At this time, file names which do not overlap each other are attached automatically to respective image information (G) by a program within the mobile communication system (B). Alternatively, if the information is written and managed, text information may be inputted by using an existing ten key which is provided in advance at the mobile communication system (B).

Then, by transferring image files to any system having a function of the communication terminal with known mobile telephone means, required digital image information (G), for example, maps or photographs can be transferred to the mobile communication system (B) another person carries.

As the known mobile telephone means, a PDC system and a CDMA system are considered. However, the PDC system and the CDMA system are used only in Japan and Korea and are particular systems from the global standpoint. In countries of Europe, Africa, Asia, and Oceania, a GMS system is generally used. In the United States, both a digital method and an analog method are used mixedly. Further, a plurality of frequency bands is utilized. Thus, the means for data communication needs to be considered in accordance with respective conditions. The most appropriate means should be selected depending on each area. Any cases selected may not cause troubles to carry out the present invention.

Next, a method for transferring the image information to the system having a function of the communication terminal (F) that other user has by using a personal computer will be described.

When the image information display member (A) is shot, its digital information (G) is stored in the recording means (D) which is usually referred to as a memory and is provided in the mobile communication system (B). Then, as shown in FIG. 3, the present invention is structured to be connected to a net line from a local area network (LAN). Thus, the digital image information is transferred to an image information server (H) or any PC (I) via an internet or the net line which includes wired or wireless LAN and/or stand-alone.

A file name which does not overlap each other is attached automatically to the image information which has transferred to the PC (I) by a program within the PC (I). By using any commercially available application software on an operating system Windows (Registered Trademark) provided by Microsoft (Registered Trademark), predetermined text information can be added to the image information. Moreover, if GIF, BMP or thumbnail image information is added to the resultant image, the image can be reedited in an Exif format. Further, batch centralized management or processing can be carried out upon the image.

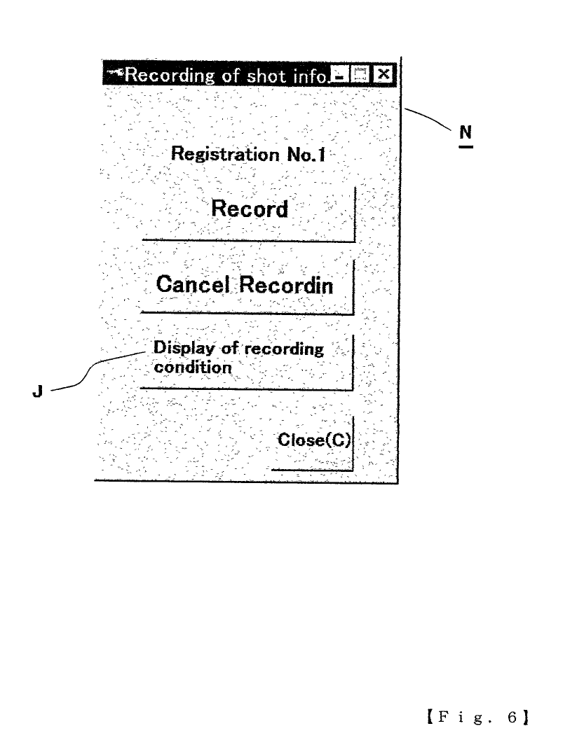

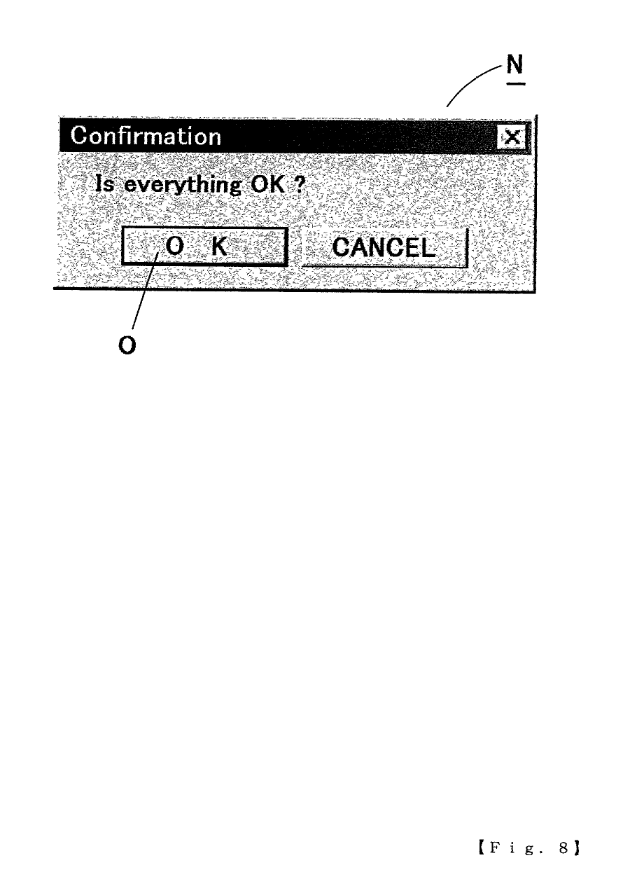

FIGS. 6 through 9 show menu screens (N) displayed on a PC (I). With reference to these drawings, in FIG. 6, a screen for confirming converting of a JPEG file fetched as described above and predetermined text information into a file name is displayed. In accordance with an instruction, a user clicks a display of recording condition (J).

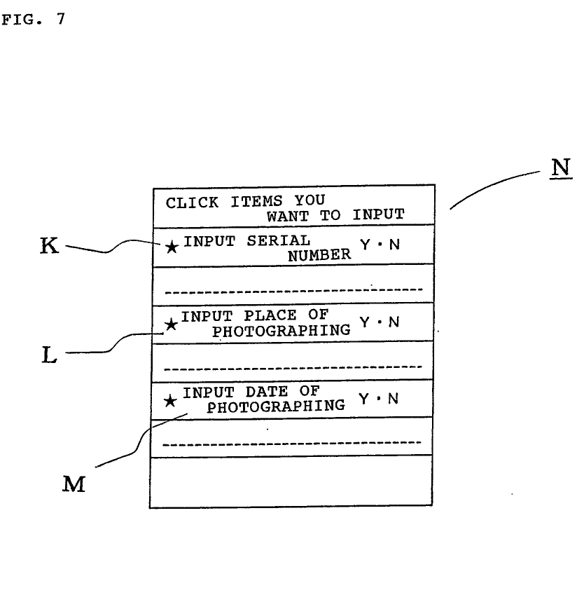

FIG. 7 is a display of a screen for clicking information that a user wants to input, wherein a menu screen (N) is displayed such that a user can input a serial number (K), a date of photographing (L) and a place of photographing (M). Input information is not limited to such information. For example, representative data such as a file name, a file type, a photographer, a climate at the time of photographing, an order of photographing and the like can be inputted if necessary. In a case of inputting such information, an existing keyboard can be used as input means.

Thereafter, a menu screen (N) for confirmation is displayed. If there are no changes, a user clicks OK (O) and then an operation ends.

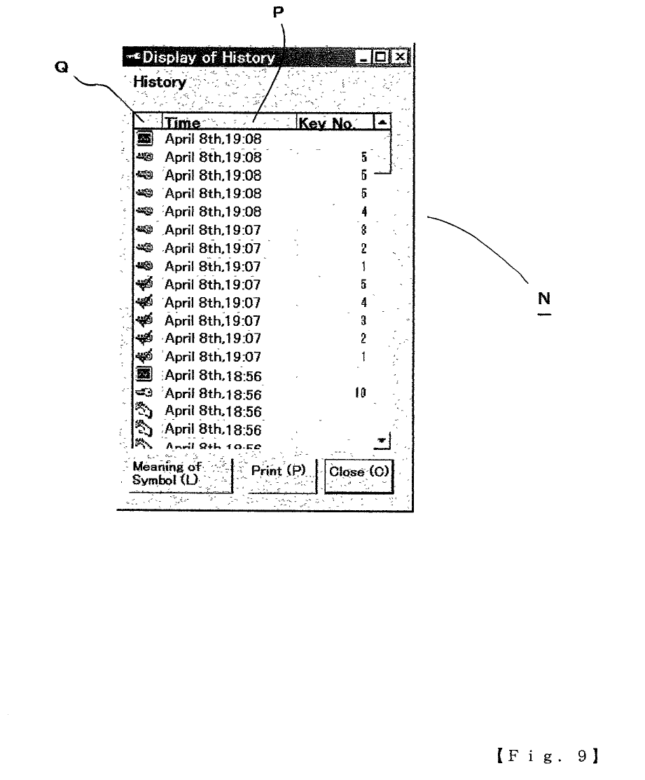

The image information (G) which is stored as describe above can be displayed as a list such as a menu screen (N) shown in FIG. 9 on a screen of a computer. The list preferably has a shell structure for visual recognition. At this time, any data word (P) such as representative data included in a computer and a serial number is preferably displayed. Further, as shown in FIG. 9, a type of a file is also preferably displayed. In a case of displaying the type of a file, a program is formed such that a type of a file is displayed as an icon (Q), and meaning of a symbol of the icon can be confirmed by clicking a button. However, the present invention is not limited to such system, and it is preferable to provide a system in which a display menu can be changed freely so as to be used easily by a user.

Although not especially shown in the drawings, it is preferable that a list can be sorted in an ascending order or in a descending order for respective categories such as file name and the like. Further, it is preferable that a displayed image can be seen directly from a list screen by using an application software associated with an extension.

The image information (G) which has been subjected to processing and batch centralized management is transferred to another PC which has the same function as a PC which carries out the processing and the batch centralized management by using, for example, known electronic mail means. As a result, required image information (G) such as maps or photographs can be transferred.

Generally, in known electronic mail means, mail data is passed to a program of a machine which is referred to as sendmail and which is designated in an SMTP server of a mailer (a tool of mail). The mail is delivered from the program to a destination of a host. Then, the mail is stored in a spool of the host. In sendmail, if a destination address is an address of a user's host, the following operations will be carried out.

1. Confirmation is carried out whether a user name is an alias. If so, the user name is rewritten and the mail is processed again.

2. If the user name is a user name of the host, the mail is added to a mail spool of the user.

If a destination address is not an address of a user's host, the following operations will be carried out.

1. Sendmail. cf is confirmed. If a special processing with respect to the mail destination is designated, a processing is carried out in accordance with the special processing.

2. If the special processing is not designated, an MX record of a host name of the mail address is researched by using DNS. Then, the mail is transferred to the resultant host.

In order to receive mails stored in the spool, a POP3 server can be used. Instead of the POP3 server, an IMAP4 server can be used. The POP3 server is used to store mails delivered to a server in a disk of the server by a provider which provides connection service of personal computers. When a receiver accesses to receive the mails, the provider supplies the receiver with the mails. When the IMAP4 server is used, the same information is duplicated so as to avoid waste of a storage capacity of the server. Further, in the IMAP4 server, required information can be searched in a server and only required portion thereof can be fetched. Basically, the IMAP4 server acts as the POP3 server. Thus, in carrying out of the present invention, either the IMAP4 server or the POP3 server can be used.

The present invention can be carried out by using, instead of an internet, a net line which includes wired or wireless LAN and/or stand-alone.

As shown in FIG. 3, the digital image information (G) stored in a PC (I) or in an image server (H) can be copied to P.P. outputted from a printer connected to a personal computer. Further, necessary digital image information (G), for example, maps or photographs can be copied to various kinds of recording mediums such as an FD, an MD and a DVD which are a portable storage medium.

Further, when the digital image information is copied, necessary information can be added to the digital image information (G), or images can be processed. Thus, it is possible to form a database for images of commodities.

Specifically, when a database for commodity catalogs or a clinical chart system including image information is to be formed, images of commodities or affected areas of patients and commodity management codes or clinical chart data can be processed at the same time by activating an application software on an operating system Windows (Registered Trademark) provided by Microsoft (Registered Trademark). As a result, there is no need of, as conventional, forming shot images of commodities or affected areas and the commodity management codes or the clinical chart separately and then combining and editing them.

As described above, in accordance with the present invention, a user can read information of an image information display member such as posters as digital image information such as JPEG by using image input means which is provided in a mobile communication system. Further, a user can record the information in a recording means which is provided in the mobile communication system and records a shot image. Accordingly, there is no need of, as conventional, writing down the information on a sheet of paper with a writing tool. Especially, the information which is likely to be mistaken such as a telephone number or a map of a place or so-called domain information with many characters such as an URL in an internet or an e-mail address can be easily recorded.

Moreover, the information can be transferred to a mobile communication system that another person carries and/or to a system having a function of a communication terminal. In the present invention, a user can access to a net line from a local area network (LAN). Digital image information stored in a PC or an image server can be copied to P.P. outputted from a printer connected to a personal computer. Further, necessary digital image information such as maps or photographs can be copied to various kinds of recording mediums serving as a portable storage medium such as an FD, an MD and a DVD. As a result, the present invention accomplishes secondary or tertiary use of digital image information.

What is claimed is:

1. A system for reading image information comprising:
an image information display member such as a poster; and
a mobile communication system for reading an image information portion of said image information display member, wherein said mobile communication system comprise:
a photographing portion which shoots at least information of said image information portion;
recording means for recording the shot image; and
a display portion which retrieves and displays any of the recorded information.

2. The system for reading image information according to claim 1, wherein photographing means includes said photographing portion, a digital camera, and a scanner.

3. The system for reading image information according to claim 1, wherein the image information stored in said recording means is structured to be transferred to a mobile communication system that another person carries and/or to a system which has a function of a communication terminal.

4. The system for reading image information according to claim 1, wherein the image information stored in said recording means is structured to be connected to a net line from a local area network (LAN).

5. The system for reading image information according to claims 1 through 4, wherein the image information stored in said recording means can be recorded in a recording medium such as a server system.

6. The system for reading image information according to claim 1, wherein the image information stored in said recording means can be copied to a recording medium such as an FD, an MD or a DVD as well as P.P.

7. The system for reading image information according to claim 1 further comprising means for displaying a desired portion of the image information stored in said recording means in an enlarged manner at a time of outputting the image information.
